(19) United States
(12) Patent Application Publication
(10) Pub. No.: US 2025/0229394 A1
(43) Pub. Date: Jul. 17, 2025

(54) CLEVIS PIN PRESS TOOL

(71) Applicant: Tiger Tool International Incorporated, Abbotsford (CA)

(72) Inventors: Michael Andrews, Bellingham, WA (US); Adam Baran, Vancouver (CA)

(73) Assignee: Tiger Tool International Incorporated, Abbotsford (CA)

(21) Appl. No.: 18/645,304

(22) Filed: Apr. 24, 2024

Related U.S. Application Data
(60) Provisional application No. 63/620,121, filed on Jan. 11, 2024.

(51) Int. Cl. B25B 27/02; B25B 27/00

(52) U.S. Cl. CPC B25B 27/023; B25B 27/0035

(57) ABSTRACT

A press tool comprises a base assembly defining a housing guide surface, a drive pin, and a guide sleeve defining a sleeve guide surface. The drive pin engages the base assembly such that axial rotation of the drive pin causes linear displacement of the drive pin relative to the base assembly. The housing guide surface engages the guide sleeve. The sleeve guide surface engages the drive pin.

### RELATED APPLICATIONS

This application (Attorney's Ref. No. P220504) claims benefit of U.S. Provisional Application Ser. No. 63/620,121 filed Jan. 11, 2024, the contents of which are incorporated here by reference.

### TECHNICAL FIELD

This invention relates to a press, in particular a press to move a pin contained in a body. The invention finds particular application in the removal of a clevis pin from a clevis.

### BACKGROUND

Pins are frequently used to secure two components together. In particular, a clevis pin may be used to secure a part to a clevis (or yoke). The clevis and rod end are formed with openings that can be aligned and the clevis pin inserted. The clevis pin has a head at one end and an opening through the other end. The pin is located by placing a split pin through the opening to secure the clevis pin in the clevis. This arrangement is widely used. The present invention is of particular significance when used to remove clevis pins of brake slack adjuster in trucks, buses, and other heavy vehicles. Accordingly, while the present invention will be described herein in the context of a clevis pin used as part of a brake slack adjuster, the present invention may be used in connection with clevis pins used for purposes in addition to or instead of a clevis pin for a brake slack adjuster.

Brake slack adjusters are used to control the adjustment of the air brakes. The rake slack adjuster comprises a housing. mounted on a shaft, with an arm extending from the housing. The brake slack adjuster is a means of taking up the slack caused by wear of the brakes and in the system. If no compensation is carried out for wear then the brakes become unsafe due to excessive travel. The additional movement necessary in the system can mean that components within the system do not align properly, which has an adverse effect on the operation of the brakes.

Like any component on a truck or heavy duty vehicle the brake slack adjusters must be serviced. They are subjected to heavy wear in adverse conditions. Corrosion is inevitable. This corrosion, in addition to reducing the efficiency of the system, also introduces problems in serving the system. These problems are compounded by the fact that the connections are frequently in inaccessible positions, making it difficult to get proper access to the components to allow their dismantling.

### RELATED ART

U.S. Pat. No. 5,271,136 discloses press systems and methods that may be used to remove the clevis pin of a brake slack adjuster. Even minor misalignment of a threaded drive member forming part of the tool disclosed in the '136 patent relative to the axis of the clevis pin can result in failure of that tool to effectively remove the clevis pin.

### SUMMARY

The present invention may be embodied as a press tool comprising a base assembly defining a housing guide surface, a drive pin, and a guide sleeve defining a sleeve guide surface. The drive pin engages the base assembly such that axial rotation of the drive pin causes linear displacement of the drive pin relative to the base assembly. The housing guide surface engages the guide sleeve. The sleeve guide surface engages the drive pin.

The present invention may also be embodied as a method of pressing a clevis pin comprising the following steps. A base assembly defining a housing guide surface is provided. A drive pin is provided. A guide sleeve defining a sleeve guide surface is provided. The drive pin is arranged to engage the base assembly such that axial rotation of the drive pin causes linear displacement of the drive pin relative to the base assembly. The guide sleeve is arranged relative to the base assembly such that the housing guide surface engages the guide sleeve. The guide sleeve is arranged relative to the base assembly such that the sleeve guide surface engages the drive pin.

### BRIEF DESCRIPTION OF THE DRAWINGS

FIG. 1 is a side elevation view of a first example press tool of the present invention;

FIG. 2 is a longitudinal side section view of the first example press tool in a fully extended configuration;

FIG. 3 is a perspective view illustrating an example braking system comprising a clevis and clevis pin assembly;

FIG. 4 is a longitudinal side section view depicting the first example press tool prior to engagement of the first example press tool with the clevis and clevis pin;

FIG. 5 is a longitudinal side section view depicting the first example press tool during pre-press engagement of the first example press tool with the clevis and clevis pin assembly;

FIG. 6 is a longitudinal side section view depicting the first example press tool during initiation of driving of the clevis pin using first example press tool;

FIG. 7 is a longitudinal side section view depicting the first example press tool during driving of the clevis pin using first example press tool;

FIG. 8 is a longitudinal side section view depicting the first example press tool after driving of the clevis pin using first example press tool;

FIG. 9 is a longitudinal side section view of a second example press tool in a fully extended configuration; and

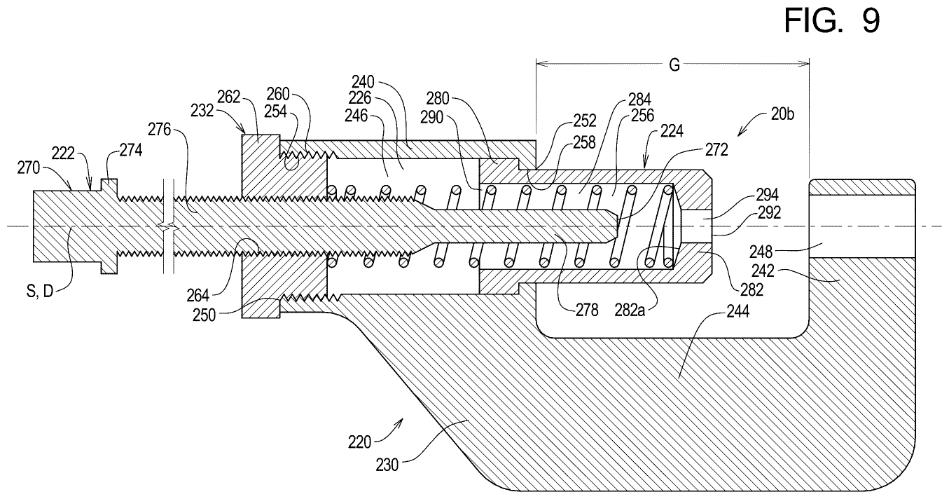

FIG. 10 is a longitudinal side section view depicting the second example press tool prior to engagement of the second example press tool with the clevis and clevis pin.

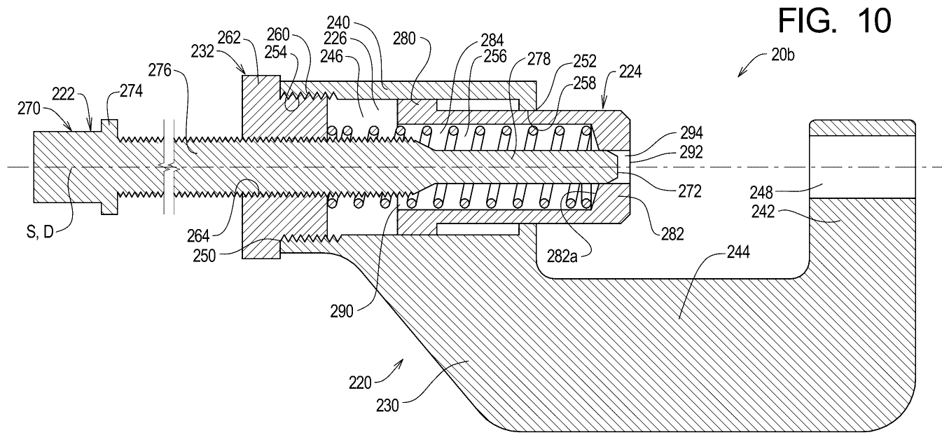

### DETAILED DESCRIPTION

The present invention may be embodied in different forms, and several example embodiments of the present invention will be described below.

### I. First Example Embodiment

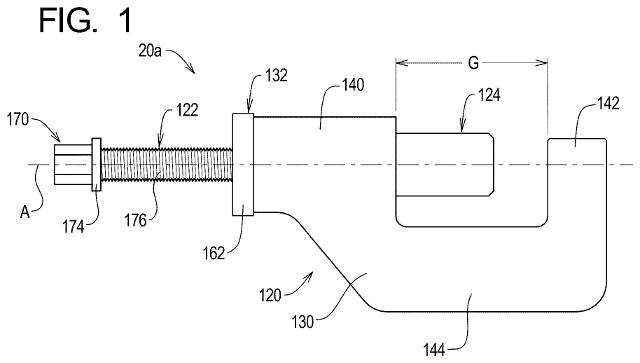

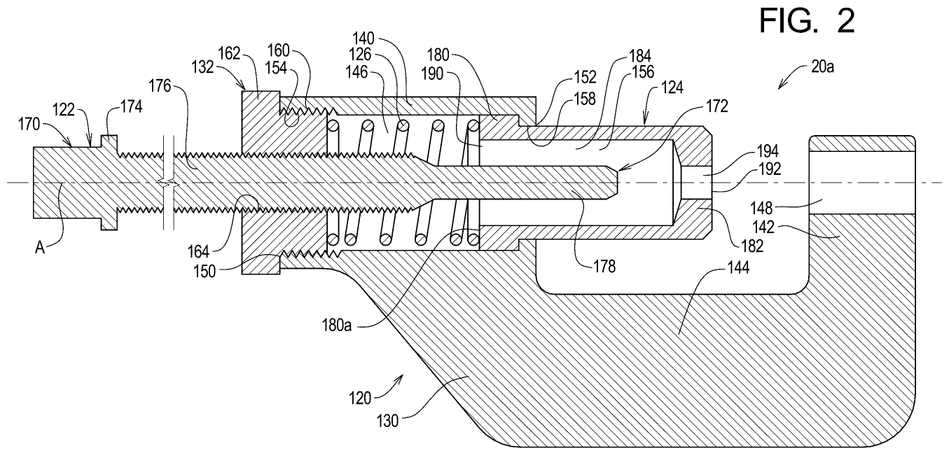

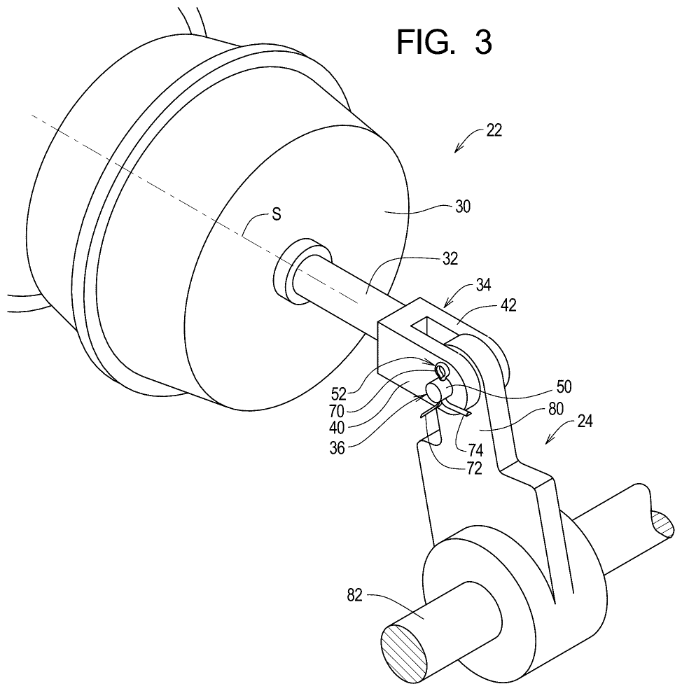

Referring now to FIGS. 1-8 of the drawing, depicted therein is a first example press tool 20a constructed in accordance with, and embodying, the principles of the present invention. The example press tool 20a is configured for use with a braking system 22 having a brake slack adjuster 24. The braking system 22 and brake slack adjuster 24 are or may be conventional and will be described herein only to that extent helpful to a complete understanding of the construction and operation of the first example press tool 20a.

The example braking system 22 comprises an air pot 30, push rod 32, clevis (or yoke) 34, and a clevis pin assembly 36. The example clevis 34 defines a first clevis arm 40 and a second clevis arm 42. The first and second clevis arms 40 and 42 define first and second clevis arm openings 44 and 46, respectively. The example clevis pin assembly 36 comprises a clevis pin 50 and a split pin 52. The example clevis pin defines a clevis pin head 60, a clevis pin shaft 62, and a clevis pin opening 64. The example split pin 52 is an elongate member, typically metal, that is bent to define a split pin loop portion 70, a split pin first end portion 72, and a split pin second end portion 74. The example brake slack adjuster 24 defines a slack adjuster arm 80 and a slack adjuster shaft 82. A slack adjuster arm opening 84 is formed in the slack adjuster arm.

The clevis pin 50 is arranged to extend through the first clevis arm opening 44, the slack adjuster arm opening 84, and the second clevis arm opening 46 such that linear movement of the push rod 32 supporting the clevis 34 is translated to pivoting movement of the slack adjuster arm 80 about an clevis pin axis defined by the clevis pin 50. The clevis pin head 60 prevents the clevis pin 50 from passing in a first direction through the first clevis arm opening 44, the slack adjuster arm opening 84, and the second clevis arm opening 46. The split pin 52 is arranged to extend through the clevis pin opening 64 to prevent the clevis pin 50 from passing in a second direction (opposite the first direction) through the first clevis arm opening 44, the slack adjuster arm opening 84, and the second clevis arm opening 46.

The first example press tool 20a may be configured to displace a first part relative to a second part in a variety of environments. The present invention is particular significance when the first part is a clevis pin such as the clevis pin 50 and the second part is a brake slack adjuster such as the brake slack adjuster 24, and that application of the present invention will be described herein in detail. However, the present invention may be used in situations other than removal of a clevis pin from a brake slack adjuster as shown and described herein.

The first example press tool 20a is configured to remove the clevis pin 50 from the first clevis arm opening 44, the slack adjuster arm opening 84, and the second clevis arm opening 46. The first example press tool 20a comprises a base assembly 120, a drive pin 122, a guide sleeve 124, and a sleeve bias spring 126.

The example base assembly comprises a base member 130 and a base cap 132. The base member 130 defines a housing portion 140, a brace portion 142, and a spacing portion 144. The spacing portion 144 rigidly connects the housing portion 140 and the brace portion 142 such that a gap G exists between the housing 140 and brace portion 142. The housing portion 140 140 defines a housing cavity 146, and the brace portion defines a brace cavity 148. A system axis S extends through the base member 130 through the housing cavity 146, across the gap G, and through the brace cavity 148. The example housing cavity 146 is a through hole defining a housing cavity first end opening 150 and a housing cavity second end opening 152. The housing portion 140 of the base member 130 defines interior housing portion 154 formed in the housing cavity 146 adjacent to the housing cavity first end opening 150. The housing portion 140 of the base member 130 further defines and interior housing restricted portion 156 formed in the housing cavity 146 adjacent to the housing cavity second end opening 152. The interior housing restricted portion 156 further defines a housing guide surface 158.

The example base cap 132 defines an outer threaded surface 160, an end flange 162, and an inner threaded surface 164. The outer threaded surface 160 is configured to engage the threaded portion 154 of the base member 130. The base cap 132 is secured to the base member 130 by threading the outer threaded surface 160 of the base cap 132 into the threaded portion 145 until the flange portion 162 comes into contact with the housing portion 140 of the base member 130.

The example drive pin 122 defines a first end 170 and a second end 172 and comprises a stop flange 174. The example drive pin 122 further defines a threaded shaft portion 176 and a press portion 178. The threaded shaft portion 176 is configured to engage the inner threaded surface 164 of the base cap 132.

The example guide sleeve 124 defines a first end flange 180, a second end flange 182, and a sleeve passageway 184 extending between the first and second end flanges 180 and 182. The example sleeve passageway 184 defines a sleeve passageway first end opening 190 and a sleeve passageway second end opening 192. The first end flange 180 extends radially outwardly from the guide sleeve 124 adjacent to the sleeve passageway first end opening 190, and the second end flange 182 extends radially inwardly from the guide sleeve 124 adjacent to the sleeve passageway second end opening 192. The example second end flange 182 of the guide sleeve 124 further defines a sleeve guide surface 194.

The example sleeve bias spring 126 is arranged within the housing cavity 146 between the base cap 132 and the guide sleeve 124 to apply a biasing force on the guide sleeve 124 away from the base cap 132. In particular, the example bias spring 126 engages an annular end surface 180a defined by the first end flange 180.

As shown in the drawing, the outer threaded surface 160 of the base cap 132 engages the threaded portion 154 of the housing cavity 146. The drive pin 122 engages the inner threaded surface 164 of the base cap 132 such that the drive axis D defined by drive pin 122 is substantially aligned with the system axis S. With the base cap 132 supported by the base member 132 and the drive pin 122 supported by the base cap 132, axial rotation of the drive pin 122 results in linear displacement of the drive pin 122 along the system axis S.

As also shown, the example base assembly 120 supports guide sleeve 124 for movement along the system axis S such that the example housing cavity 146, brace cavity 148, sleeve passageway 184 are all substantially aligned with the system axis S. The drawing figures illustrate that a diameter of the guide sleeve 124 between the first and second end flanges 180 and 182 is substantially the same as, but slightly smaller than, a diameter of the restricted portion 156. The drawing figures further illustrate that a diameter of the example press portion 178 is smaller than a diameter of the example threaded shaft portion 176 and substantially the same as, but slightly smaller than, a diameter of the sleeve passageway second end opening 192. The housing guide surface 158 thus acts on the guide sleeve 124 to maintain linear movement of the guide sleeve 124 along the system axis S, while the sleeve guide surface 194 acts on the press portion 178 of the drive pin 122 to maintain linear movement of the drive pin 122 along the system axis S. A diameter of the first end flange 180 of the guide sleeve 124 is larger than a diameter of the housing cavity second end opening 152 to limit movement of the guide sleeve 124 relative to the base assembly 120.

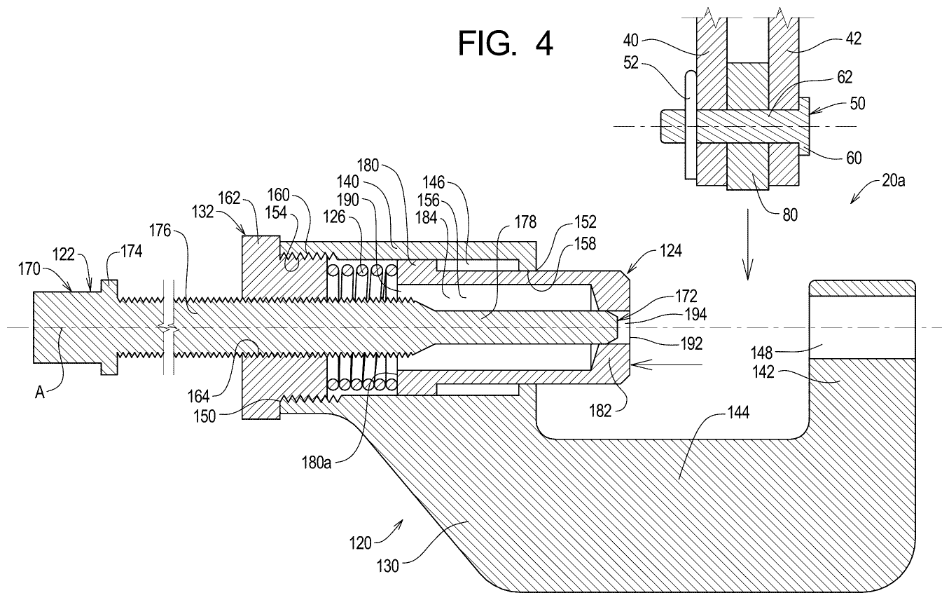

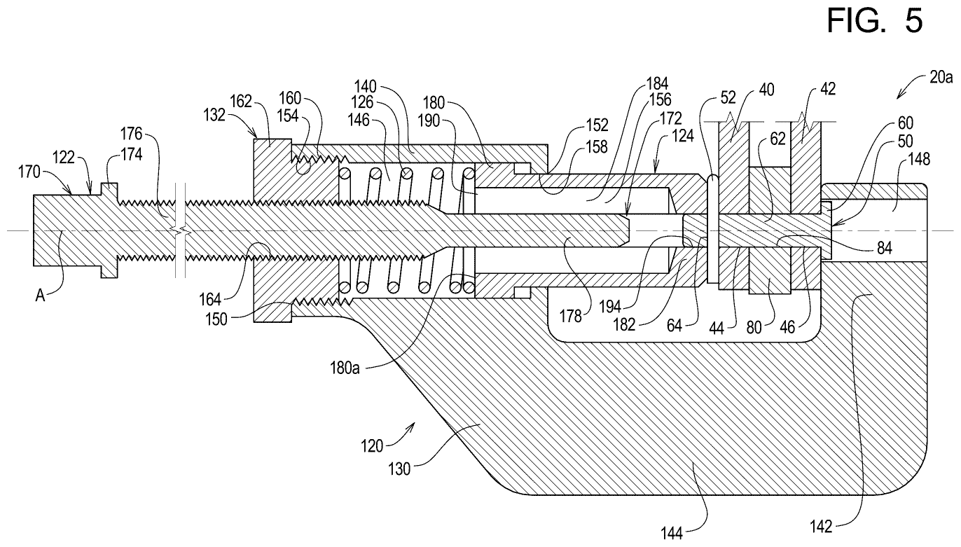

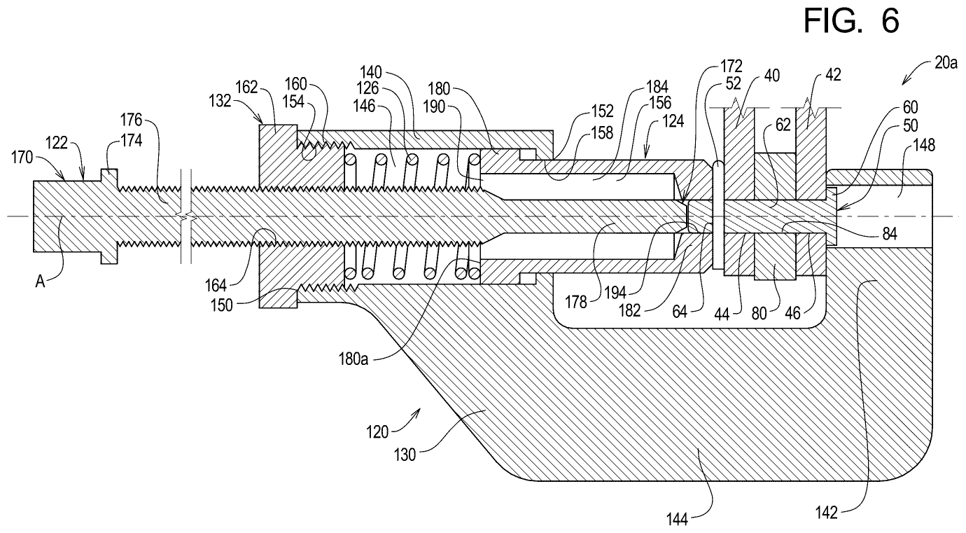

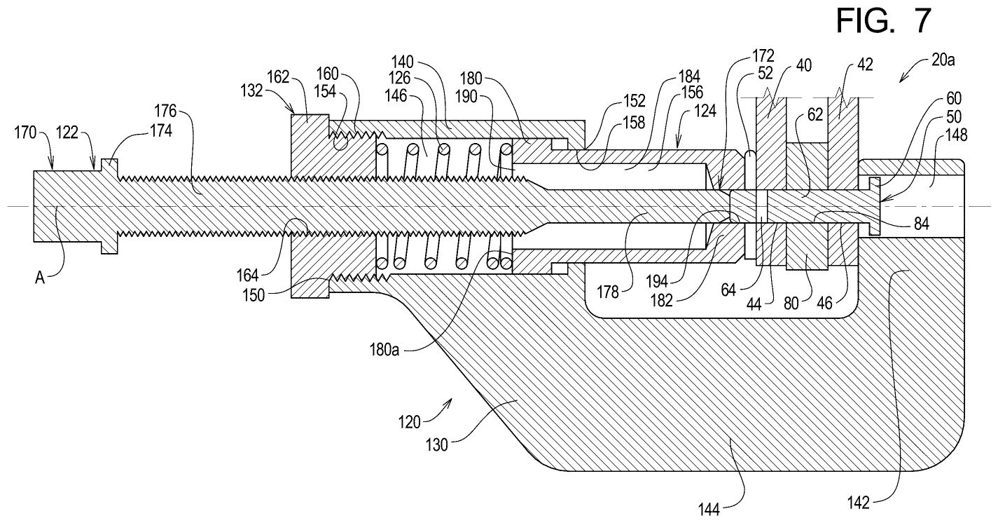

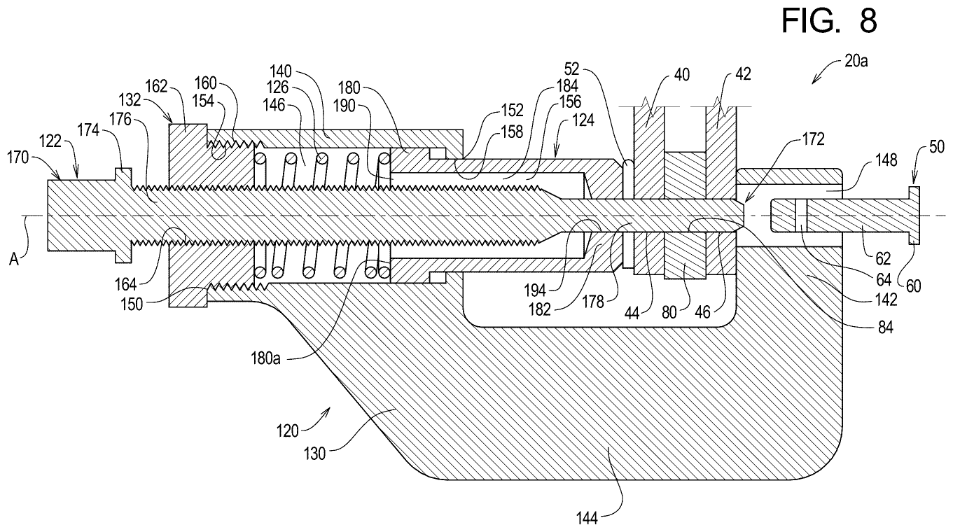

In use, while manually retracting the guide sleeve 124 within the housing cavity 146 against the force of the sleeve bias spring 126, at least a portion of the clevis 34 is arranged within the gap G such that an axis of the clevis pin 50 is substantially aligned with the drive axis D as shown in FIGS. 4 and 5. The guide sleeve 124 is then released such that the guide sleeve 124 engages the split pin 52 as shown in FIG. 5. The drive pin 122 is then axially rotated until the press portion 178 thereof engages the clevis pin 50 as shown in FIG. 6. Further axial rotation of the press pin 122 shears the clevis pin 50 and begins forcing the clevis pin 50 out of the clevis arm opening 46 as shown in FIG. 7. Continued axial rotation of the press pin 122 forces the clevis pin 50 completely out of the arm opening 46 as shown in FIG. 8.

The guide surfaces 158 and 194 substantially maintain linear movement of the guide sleeve 124 and the drive pin 122 during removal of the clevis pin 50.

### II. Second Example Embodiment

Referring now to the drawing, depicted therein is a second example press tool 20b constructed in accordance with, and embodying, the principles of the present invention. The example press tool 20b is configured for use with a braking system 22 having a brake slack adjuster 24. The braking system 22 and brake slack adjuster 24 are or may be conventional and will be described herein only to that extent helpful to a complete understanding of the construction and operation of the second example press tool 20b.

The example braking system 22 comprises an air pot 30, push rod 32, clevis (or yoke) 34, and a clevis pin assembly 36. The example clevis 34 defines a first clevis arm 40 and a second clevis arm 42. The first and second clevis arms 40 and 42 define first and second clevis arm openings 44 and 46, respectively. The example clevis pin assembly 36 comprises a clevis pin 50 and a split pin 52. The example clevis pin defines a clevis pin head 60, a clevis pin shaft 62, and a clevis pin opening 64. The example split pin 52 is an elongate member, typically metal, that is bent to define a split pin loop portion 70, a split pin first end portion 72, and a split pin second end portion 74. The example brake slack adjuster 24 defines a slack adjuster arm 80 and a slack adjuster shaft 82. A slack adjuster arm opening 84 is formed in the slack adjuster arm.

The clevis pin 50 is arranged to extend through the first clevis arm opening 44, the slack adjuster arm opening 84, and the second clevis arm opening 46 such that linear movement of the push rod 32 supporting the clevis 34 is translated to pivoting movement of the slack adjuster arm 80 about a clevis pin axis defined by the clevis pin 50. The clevis pin head 60 prevents the clevis pin 50 from passing in a first direction through the first clevis arm opening 44, the slack adjuster arm opening 84, and the second clevis arm opening 46. The split pin 52 is arranged to extend through the clevis pin opening 64 to prevent the clevis pin 50 from passing in a second direction (opposite the first direction) through the first clevis arm opening 44, the slack adjuster arm opening 84, and the second clevis arm opening 46.

The second example press tool 20b may be configured to displace a first part relative to a second part in a variety of environments. The present invention is of particular significance when the first part is a clevis pin such as the clevis pin 50 and the second part is a brake slack adjuster such as the brake slack adjuster 24. The second example press tool 20b may thus be used in the same manner as the first example press tool 20a, the description of use of the second example press tool 20b will not be repeated herein. And like the first example press tool 20a, the present invention may be used in situations other than removal of a clevis pin from a brake slack adjuster as shown and described above.

The example press tool 20b comprises a base assembly 220, a drive pin 222, a guide sleeve 224, and a sleeve bias spring 226.

The example base assembly comprises a base member 230 and a base cap 232. The base member 230 defines a housing portion 240, a brace portion 242, and a spacing portion 244. The spacing portion 244 rigidly connects the housing portion 240 and the brace portion 242 such that a gap G exists between the housing 240 and brace portion 242. The housing portion 240 defines a housing cavity 246, and the brace portion defines a brace cavity 248. A system axis S extends through the base member 230 through the housing cavity 246, across the gap G, and through the brace cavity 248. The example housing cavity 246 is a through hole defining a housing cavity first end opening 250 and a housing cavity second end opening 252. The housing portion 240 of the base member 230 defines interior housing portion 254 formed in the housing cavity 246 adjacent to the housing cavity first end opening 250. The housing portion 240 of the base member 230 further defines and interior housing restricted portion 256 formed in the housing cavity 246 adjacent to the housing cavity second end opening 252. The interior housing restricted portion 256 further defines a housing guide surface 258.

The example base cap 232 defines an outer threaded surface 260, an end flange 262, and an inner threaded surface 264. The outer threaded surface 260 is configured to engage the threaded portion 254 of the base member 230. The base cap 232 is secured to the base member 230 by threading the outer threaded surface 260 of the base cap 232 into the threaded portion 254 until the flange portion 262 comes into contact with the housing portion 240 of the base member 230.

The example drive pin 222 defines a first end 270 and a second end 272 and comprises a stop flange 274. The example drive pin 222 further defines a threaded shaft portion 276 and a press portion 278. The threaded shaft portion 276 is configured to engage the inner threaded surface 264 of the base cap 232.

The example guide sleeve 224 defines a first end flange 280, a second end flange 282, and a sleeve passageway 284 extending between the first and second end flanges 280 and 282. The example sleeve passageway 284 defines a sleeve passageway first end opening 290 and a sleeve passageway second end opening 292. The first end flange 280 extends radially outwardly from the guide sleeve 224 adjacent to the sleeve passageway first end opening 290, and the second end flange 282 extends radially inwardly from the guide sleeve 224 adjacent to the sleeve passageway second end opening 292. The example second end flange 282 of the guide sleeve 224 further defines a sleeve guide surface 294.

The example sleeve bias spring 226 is arranged within the housing cavity 246 between the base cap 232 and the guide sleeve 224 to apply a biasing force on the guide sleeve 224 away from the base cap 232. In particular, the example bias spring 226 engages an inner surface 282a defined by the second end flange 282.

As shown in the drawing, the outer threaded surface 260 of the base cap 232 engages the threaded portion 254 of the housing cavity 246. The drive pin 222 engages the inner threaded surface 264 of the base cap 232 such that the drive axis D defined by drive pin 222 is substantially aligned with the system axis S. With the base cap 232 supported by the base member 230 and the drive pin 222 supported by the base cap 232, axial rotation of the drive pin 222 results in linear displacement of the drive pin 222 along the system axis S.

As also shown, the example base assembly 220 supports guide sleeve 224 for movement along the system axis S such that the example housing cavity 246, brace cavity 248, sleeve passageway 284 are all substantially aligned with the system axis S. The drawing figures illustrate that a diameter of the guide sleeve 224 between the first and second end flanges 280 and 282 is substantially the same as, but slightly smaller than, a diameter of the restricted portion 256. The drawing figures further illustrate that a diameter of the example press portion 278 is smaller than a diameter of the example threaded shaft portion 276 and substantially the same as, but slightly smaller than, a diameter of the sleeve passageway second end opening 292. The housing guide surface 258 thus acts on the guide sleeve 224 to maintain linear movement of the guide sleeve 224 along the system axis S, while the sleeve guide surface 294 acts on the press portion 278 of the drive pin 222 to maintain linear movement of the drive pin 222 along the system axis S. A diameter of the first end flange 280 of the guide sleeve 224 is larger than a diameter of the housing cavity second end opening 252 to limit movement of the guide sleeve 224 relative to the base assembly 220.

In use, while manually retracting the guide sleeve 224 within the housing cavity 246 against the force of the sleeve bias spring 226, at least a portion of the clevis 34 may be arranged within the gap G such that an axis of the clevis pin 50 is substantially aligned with the drive axis D. The guide sleeve 224 is then released such that the guide sleeve 224 engages the split pin 52. The drive pin 222 is then axially rotated until the press portion 278 thereof engages the clevis pin 50. Further axial rotation of the press pin 222 shears the clevis pin 50 and begins forcing the clevis pin 50 out of the clevis arm opening 46. Continued axial rotation of the press pin 222 forces the clevis pin 50 completely out of the arm opening 46.

The guide surfaces 258 and 294 substantially maintain linear movement of the guide sleeve 224 and the drive pin 222 during removal of the clevis pin 50.

1. A press tool comprising:
a base assembly comprising
a base member defining a housing guide surface, a system axis, and a housing cavity, and
a base cap;
a drive pin;
a bias member; and
a guide sleeve defining a sleeve guide surface; wherein
the guide sleeve is supported by the base member such that at least a portion of the guide sleeve is within the housing cavity;
the bias member is arranged within the housing cavity to bias the guide sleeve relative to the base member;
the base cap is detachably attached to the base member to maintain at least a portion of the guide sleeve and the bias member within the housing cavity;
the base assembly supports the drive pin for movement along the system axis;
the housing guide surface engages the guide sleeve; and
the sleeve guide surface engages the drive pin.

2. A method of pressing a clevis pin comprising the following steps:
providing a base member defining a housing guide surface, a system axis, and a housing cavity;
providing a base cap;
providing a drive pin;
providing a bias member; and
providing a guide sleeve defining a sleeve guide surface;
supporting the guide sleeve with the base member such that at least a portion of the guide sleeve is within the housing cavity;
arranging the bias member within the housing cavity to bias the guide sleeve relative to the base member;
detachably attaching the base cap to the base member to maintain at least a portion of the guide sleeve and the bias member within the housing cavity;
supporting the drive pin for movement along the system axis;
arranging the guide sleeve relative to the base assembly such that the housing guide surface engages the guide sleeve; and
arranging the guide sleeve relative to the base assembly such that the sleeve guide surface engages the drive pin.

3. A press tool as recited in claim 1, in which:
the guide sleeve further defines a sleeve passageway extending between first and second end openings; and
the guide sleeve is arranged such that the first end opening is within the housing cavity and the second end opening is outside of the housing cavity.

4. A press tool as recited in claim 1, in which:
the guide sleeve further defines a sleeve passageway, at least one first end projection, and at least one second end projection; and
the guide sleeve is arranged such that the at least one first end projection is within the housing cavity and the at least one second end projection is outside of the housing cavity.

5. A press tool as recited in claim 4, in which:
the at least one first end projection extends radially outward relative to the sleeve opening; and
the at least one second end projection extends radially inward relative to the sleeve opening.

6. A press tool as recited in claim 4, in which the at least one second end projection defines the sleeve guide surface.

7. A press tool as recited in claim 5, in which the at least one second end projection defines the sleeve guide surface.

8. A press tool as recited in claim 1, in which:
the guide sleeve further defines a sleeve passageway, a first end projection defining a first end opening, and a second end projection defining a second end opening; and
the guide sleeve is arranged such that the first end projection is within the housing cavity and the second end projection is outside of the housing cavity.

9. A press tool as recited in claim 8, in which the at least one second end projection defines the sleeve guide surface.

10. A press tool as recited in claim 1, in which:
the guide sleeve further defines a sleeve passageway and first and second end projections; and
the bias member is arranged at least partly within the sleeve passageway to engage the second end projection.

11. A press tool as recited in claim 1, in which:
the guide sleeve further defines first and second end projections; and
the bias member is arranged to engage the first end projection.

12. A press tool as recited in claim 1, in which:
the guide sleeve further defines a sleeve passageway and at least one end projection, where the at least one end projection defines the sleeve guide surface; and
at least a portion of the pin member is arranged at least partly within the sleeve passageway.

13. A press tool as recited in claim 1, in which the drive pin engages the base cap such that axial rotation of the drive pin displaces the drive pin along the system axis.

14. A press tool as recited in claim 5, in which:
the at least one first end projection is a first end flange that extends radially outward relative to the sleeve opening; and
the at least one second end projection is a second end flange that extends radially inward relative to the sleeve opening.

15. A press tool comprising:
a base assembly comprising
a base member defining a housing guide surface, a system axis, and a housing cavity, and
a base cap;
a drive pin;
a bias member; and
a guide sleeve a sleeve passageway extending between first and second end openings, a first end flange defining the first end opening, and a second end flange defining the second end opening and the sleeve guide surface; wherein
the guide sleeve is supported by the base member such that the first end flange is within the housing cavity and the second end flange is outside of the housing cavity;
the bias member is arranged within the housing cavity to bias the guide sleeve relative to the base member;
the base cap is detachably attached to the housing cavity second end opening to maintain the first end flange and the bias member within the housing cavity;
the base cap supports the drive pin such that axial rotation of the drive pin displaces the drive pin along the system axis;
the housing guide surface engages the guide sleeve; and
the sleeve guide surface engages the drive pin.

16. A press tool as recited in claim 15, in which the at least one first end flange extends radially outward relative to the sleeve opening and the at least one second end flange extends radially inward relative to the sleeve opening.

17. A press tool as recited in claim 15, in which the bias member is arranged at least partly within the sleeve passageway to engage the second end flange.

18. A press tool as recited in claim 15, in which the bias member is arranged to engage the first end flange.

19. A press tool as recited in claim 15, in which at least a portion of the pin member is arranged at least partly within the sleeve passageway.
